(19) United States
(12) Patent Application Publication
(10) Pub. No.: US 2009/0306924 A1
(43) Pub. Date: Dec. 10, 2009

(54) AUTOMATIC CALIBRATION SYSTEM FOR SCANNER-SCALE OR OTHER SCALE SYSTEM

(75) Inventor: Bryan L. Olmstead, Eugene, OR (US)

Correspondence Address: DATALOGIC - STOEL RIVES LLP;C/O STOEL RIVES LLP, 900 SW 5TH AVENUE, SUITE 2600, PORTLAND, OR, 97204, US

(73) Assignee: Datalogic Scanning, Inc., Eugene, OR (US)

(21) Appl. No.: 12/435,997

(22) Filed: May 5, 2009

Related U.S. Application Data
(60) Provisional application No. 61/060,414, filed on Jun. 10, 2008.

(51) Int. Cl. G01G 23/01

(52) U.S. Cl. 702/101

(57) ABSTRACT

A system and method for automatically calibrating a scale, particularly a scanner-scale of a POS system, in which the scale is calibrated via an on-board calibration system including an accelerometer that actually measures the acceleration due to gravity factor for a given location/time and then uses this measured factor to perform a calibration sequence. An example calibration method may include the steps of (a) performing an initial calibration on the scanner-scale during assembly; (b) providing the scanner-scale with an on-board accelerometer operable to measure gravity acceleration constants for the current location; and (c) running a calibration routine using the specific calibration data obtained from the measurement in step (b) to calibrate the scale. In one configuration, the system may also use other sensors, including temperature and humidity sensors, to provide further calibration constants for use in calibrating the accelerometer and the scale strain gage.

### REALTED ART

This application claims priority to provisional application No. 61/060,414 filed Jun. 10, 2008, hereby incorporated by reference.

### BACKGROUND

The field of the present disclosure relates to systems and methods for scale calibration of a data reading system. A typical high volume data reading system used at a grocery store, for example, is an optical scanner having an integrated scale (e.g. a scanner-scale). Scale calibration sets the scale to an accurate reference point for weighing. Scale calibration is a time-consuming procedure that is typically governed by governmental weights and measures statutes. Current scanner-scale products typically require technicians to use a weight set to calibrate the scanner after installation. In addition, these scanner-scale products often need official registration and labeling by weights and measures officials to certify that the scale may be used for commerce.

Previously suggested calibration methods include use of standardized weights, for example, pre-measured 1 Kg and 3 Kg weights are alternately placed on the scale and a calibration system then performs a calibration sequence. In another method such as disclosed in U.S. application Ser. No. 2002/0052703, hereby incorporated by reference, the scale includes a communications interface to obtain scale calibration data (acceleration due to gravity data) pertaining to the scale's location. Such a system requires a communication link or a location system (e.g., a global positioning system or “GPS”) to determine the scale's location and then the system utilizes the location calibration data in performing a calibration sequence.

The present inventor has recognized the desirability to eliminate the required manual on-site calibration of the scale portion of a scanner-scale product by local weights and measures authorities but nonetheless be in compliance with state or local weights and measures requirements and obtain the necessary certification. Factory certification would eliminate the need for customers to perform the additional calibration/certification step of setting calibration weights on the scale and running the calibration sequence.

### SUMMARY

The present invention is directed to a system and method for calibrating a scale, particularly a scanner-scale of a POS system. In a preferred system/method, a scanner-scale has its scale calibrated via an on-board calibration system including an accelerometer that measures actual acceleration due to gravity factor for a given location/time and then uses this measurement to calibrate. A preferred calibration method may comprise the steps of (a) performing an initial calibration on the scanner-scale during assembly; (b) providing the scanner-scale with an on-board accelerometer operable to measure gravity acceleration constants for the current location; and (c) running, preferably in the scanner-scale microcontroller, a calibration routine using the specific calibration data obtained from the measurement in step (b) to calibrate the scale. In certain embodiments, the system may also use other sensors, particularly a temperature sensor and additionally pressure or humidity sensors, to provide further calibration constants for use in calibrating the accelerometer and/or the scale strain gage.

### BRIEF DESCRIPTION OF THE DRAWINGS

FIG. 1 is perspective a view of a scanner-scale embodying a preferred embodiment.

FIG. 2 is a block diagram of the electronics of a calibration system according to a preferred embodiment.

### DETAILED DESCRIPTION OF THE DESCRIPTION

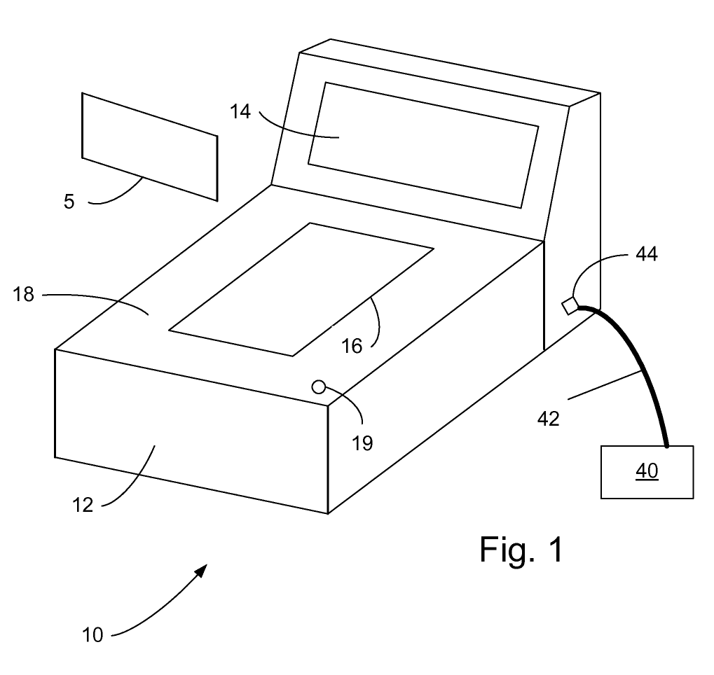

The preferred embodiments will now be described with reference to the drawings. FIG. 1 illustrates a combined data reader-scale in the form of a scanner-scale 10 of a preferred configuration, such as the Magellan® scanner-scale available from Datalogic Scanning, Inc. of Eugene, Oreg. The Magellan® scanner-scale is a multi-window laser barcode scanner having a housing 12 with a vertical window 14 and a horizontal window 16. The horizontal window 16 is integrated into the weigh platter 18. Alternately, the scanner-scale may comprise a single window scanner, the window being oriented either vertically or horizontally. The scanner-scale may comprise other types of data readers such as an imaging scanner, RFID reader or other data acquisition system.

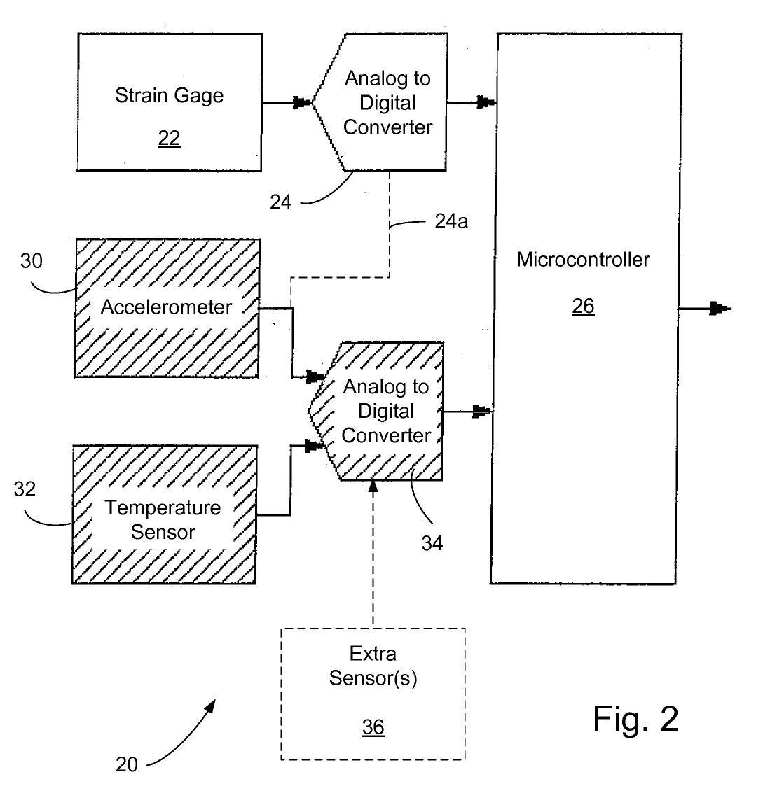

In a preferred system, the scanner-scale 10 is assembled and calibrated at the factory (or other suitable calibration location) and shipped to a location for installation without additional regional calibration. FIG. 2 is a block diagram of the electronics 20 of an automatically calibrated scale system according to a preferred embodiment. A typical low cost scale includes an analog to digital converter (ADC) 24, a microcontroller 26, and a strain gage 22 (or other suitable weight sensor or weighing mechanism). In a preferred configuration, the additional components provided to implementing an automatically calibrated scale are shown as shaded in FIG. 2 and include an accelerometer 30, a temperature sensor 32, and an analog to digital converter (ADC) 34. For an accelerometer having an analog output, the system may be connected to (via line 24a, shown in dashed lines) and use the same ADC 24 that already is used to convert the analog signal from the strain gage 22, thus simplifying the design. Alternately, the accelerometer 30 may be provided with its own ADC 34. The ADC 34 may be integral with the accelerometer 30 or separate therefrom. Upon power up, the microcontroller 26 retrieves the last calibration value from permanent memory (such as flash or EEPROM). This calibration value is used to convert strain gage readings to weight values. The accelerometer 30 is preferably mounted inside the scale 18 so that its sensitive axis is vertical (in the direction of gravity). Alternatively, there exist multi axis accelerometers which simplify the mounting process. If a three axis accelerometer 30 is used, the outputs from the X,Y, and Z axis are summed in a vector fashion (by taking the square root of the sum of squares of the individual outputs) to yield the gravity acceleration regardless of the physical orientation of the accelerometer.

Acceleration measurements are taken from the accelerometer 30 and filtering is performed to reduce the effects of vibration, etc., as is done with the strain gage input, in order to return a stable acceleration adjustment constant, which represents gravity. A temperature measurement from the temperature sensor 32 is made at this time and this temperature measurement is used to adjust the acceleration measurements, to compensate for temperature sensitivity of the accelerometer. This acceleration adjustment constant is scaled by the gravity constant at the original factory calibration and then used to adjust the scale's factory calibration for converting strain gage readings to calibrate weight values.

The system 20 may optionally include additional sensors 36, labeled as ¢Extra Sensors∞, to provide additional calibration factors for the accelerometer. The extra sensors may include one or more of the following: barometric pressure sensor, humidity sensor. Input from any of the sensors (temperature, barometric pressure, humidity, etc.) may be used to calibrate not only the accelerometer but also the scale itself. Compensation for the non-accelerational sensitivity of the accelerometer (such as temperature sensitivity) allows it to be used as a high accuracy gravity sensing device.

Temperature calibration of the system in the factory can be performed by measuring accelerometer values and temperature on circuit boards in a controlled temperature environment at two different temperatures. This data can be stored in flash or EEPROM to calibrate the calibration system. Nonlinear temperature sensitivity can be compensated by taking measurements at more than two temperatures. The assembled scale is calibrated in the factory and the accelerometer (gravity) value is stored for comparison at the local installation site.

Accelerometers, as the name suggests, are devices that measure acceleration. In recent years, these devices have become much more affordable due to new manufacturing methods. A preferred cost effective type of accelerometer is surface micromachining of so-called MEMS devices (micro electromechanical systems). These devices measure one or more orthogonal accelerations. Some devices can measure static (DC) accelerations, such as gravity. These devices typically comprise a cantilever beam with a proof mass on the end. Deflection of the beam is sensed by several methods, such as capacitance change. MEMS accelerometers are somewhat temperature sensitive, as temperature adjusts the beam spring constant, among other parameters. To provide a stable measurement, temperature is preferably measured and used in calibrating the accelerometer.

Currently, the Analog Devices model no. ADT75 temperature sensor, ADXL330 three-axis accelerometer, and the model no. AD7730 analog to digital converter (which may be used for the strain gage as well) are good candidates for the accelerometer and sensor components. The ADC would already be in the system. The temperature sensor costs less than $1.00 in 1K quantity and the accelerometer costs less than $5.50 in 1K quantity. So it is conceivable that in 10K quantity, which is more appropriate for scales, the additional cost to implement an automatically calibrated scale would be around $3.00. Other methods are available to measure temperature at potentially lower cost than an integrated temperature sensor, such as the model ADT75. For example, a thermistor or even the voltage of a simple junction diode may be used to sense temperature.

Eliminating calibration may result in reduced installation costs both at initial installation as well as when scanners are removed for repair. This reduced installation cost may result in lower cost of ownership for the customer by eliminating need to have someone certified by Weights and Measures to perform calibration.

Following are several example methods for operating an automatic calibration system.

In a first example method (Method 1), a scanner scale calibration mode is activated by steps of (a) entering the calibration sequence by either (i) activating a switch 19 (disposed on the housing 12 or at some other suitable location) as shown in FIG. 1 or (ii) activating a “soft switch” via scanning a programming label 5 or (iii) via a command from the POS (either from manual prompt or automatically) or (iv) automatically upon startup or (v) periodically by a suitable criteria; (b) once in scale calibration sequence/mode, calibrating the accelerometer, by adjusting for temperature and/or pressure and/or humidity; (c) using the accelerometer to measure gravity acceleration constants for the current location; and (d) running a calibration routine using the specific calibration data obtained from the measurement in step (b) to auto-calibrate the scale. Suitable criteria for periodic calibration include (a) at a specific time, e.g. daily or weekly; (b) upon certain weighing events such as after a certain number of weighing events, or after a certain large weighing event, or (c) combinations thereof.

Step (b) of Method 1 is elaborated as follows. Suppose the output of the accelerometer is a voltage V. A typical accelerometer has a voltage offset V0 with no acceleration and a voltage output that is proportional to acceleration A, with proportionality constant S (also known as the sensitivity of the accelerometer). So the output voltage V of the accelerometer follows as equation 1:

V=V0+S*A Equation 1

The offset V0 and sensitivity S are typically temperature sensitive. The effects of temperature on these two parameters are illustrated in equation 2, where k1 is the thermal offset coefficient and k2 is the thermal sensitivity coefficient.

V=V0+k1*T+(S+k2*T)*A Equation 2

A calibration process is used in the factory to determine constants k1 and k2. One method for obtaining these constants is described presently. The voltage output V1 of the accelerometer under test is measured at a constant temperature T1 and a physical orientation with respect to plumb (such as oriented in the direction of the earth's gravity), as shown in Equation 3. A second measurement V2 is taken at temperature T1 with a physical orientation 180° from the first measurement (such as opposite in the direction of the direction of earth's gravity), as shown in Equation 4.

V1=V0+k1*T1+(S+k2*T1)*A Equation 3

V2=V0+k1*T1+(S+k2*T1)*(−A) Equation 4

The average of these voltages X1 is shown in Equation 5. The difference between these voltages Y1 is shown in Equation 6. Equation 5 eliminates all sensitivity components, while Equation 6 eliminates all offset components.

X1=(V1+V2)/2=V0+k1*T1 Equation 5

Y1=(V1−V2)=2*(S+k2*T1)*A Equation 6

These same measurements are taken at a different temperature T2, yielding Equations 7 and 8.

X2=V0+k1*T2 Equation 7

Y2=2*(S+k2*T2)*A Equation 8

Since gravity (A) is known at the calibration site, and the temperatures T1 and T2 are known, equations 5,6,7, and 8 are four linear equations with four unknowns (V0,S,k1, and k2). It is a straightforward method to solve for these unknowns to obtain the offset voltage V0, sensitivity S, thermal offset coefficient k1, and thermal sensitivity coefficient k2. These values are stored in flash or EEPROM as calibration data for the accelerometer.

Step (c) of Method 1 is elaborated as follows. In the factory, the calibration constants V0,S,k1, and k2 were computed and stored in permanent memory (flash or EEPROM, for example). A measurement V from the accelerometer is obtained and the temperature T is measured. The acceleration value A is determined from Equation 9 (derived from equation 3). Because the measurement V from the accelerometer is filtered to reduce the effects of vibration, the acceleration A derived from Equation 9 represents the local acceleration of gravity, which we can denote as g.

A=(V−V0−k1*T)/(S+k2*T) Equation 9

When the scale is initially calibrated, the gravity measurement g0 is stored in flash or EEPROM and sets the reference gravity measurement for the scale. When the gravity g1 is measured in the current location, as described in step (c) of Method 1, a gravity factor gf is computed as shown in Equation 10 and is used to adjust the weight readings from the scale to reflect the local gravity conditions.

gf=g0/g1 Equation 10

Finally, step (d) of Method 1 is elaborated as follows. The gravity factor gf is used to modify the weight measured from the scale to reflect the local gravity conditions as shown in equation 11, where “uncompensated weight” is the weight that is returned by the scale using the load cell calibration constants from the factory calibration procedure.

Weight=gf*(Uncompensated weight) Equation 11

Preferably, the accelerometer 30 is disposed at a suitable location within the scanner housing. As described above, the preferred configuration for the accelerometer is an integrated circuit, typically mounted on a PCB. Within the scanner, a suitable PCB for the accelerometer includes: the scale PCB, primary (main) scanner PCB, or a separate PCB such as one plugged into one of the other PCB's. Alternately, the accelerometer could be located external to the scanner or scale, for example at the POS, or even an external portable data terminal (PDT) or other device capable of communicating to the scanner such as an accelerometer module plugged into an external communication port of the scanner. Such a module device is diagrammatically illustrated in FIG. 1 whereby a portable unit 40 includes a housing containing an internal processor and accelerometer. The unit 40 is connectable to the scanner-scale 10 via a connector cable 42 connected to the USB port 44 on the scanner housing. The calibration program is resident in the module 40, interfacing with the scanner-scale via the connector to provide calibration information.

In a second example method (Method 2), auto-calibration is activated and completed via an interface to a PC, a POS terminal, a portable data terminal (PDT) or other device capable of communicating to the scanner. For example, the PC may contain in memory information corresponding to accelerometer calibration data for the various temperatures or pressures as sensed by the sensor(s) 32, 36. The PC, for example, takes the output from accelerometer 30 and makes a suitable adjustment to the scale gravity calibration factor based upon temperature (or other sensor) input. Accelerometer calibration information may be stored in memory or downloaded from the accelerometer manufacturer's website.

Upon calibration, the scanner may provide visual and/or auditory means of indicating the acceptance or rejection of the auto-calibration.

As previously described, the system may be activated into the auto-calibration sequence/mode via programming labels, such as the Code 128 programming labels, whereupon scanning the specific scale calibration programming label provides a command to initiate auto-calibration. In any of the above methods utilizing programming labels, the scanner-scale 10 may be shipped with specific calibration bar code labels, such as attached to the weigh platter. In the event the weigh platter is removable, bar code labels may be applied to the platter (e.g. on the underside), the scanner-scale placed in calibration mode, the platter removed and passed over the scan window to scan the labels thereby providing calibration data to the auto-calibration system (whether resident in the scale, the POS, PC or other location). The correct labels may then be installed at the factory (or elsewhere). The labels may also be printed to include human-readable characters.

The programming labels may be any suitable type of programming label such as modified from UPC, EAN or JAN; custom programming Code 39 labels; or programming labels made in accordance with the AIM 128 standard. Though each of these labels may comprise a standard 1-D bar code label, other types of symbologies or labels may be used such as 2-D; PDF-417; bar code labels with add-on codes; or RFID tags. The system may first require an “enter programming” label be scanned, and then additional labels containing the calibration or location data may be subsequently scanned.

The auto-calibration system may be combined with other systems or its calibration checked and re-calibrated onsite by a conventional system in similar fashion as how the system is initially calibrated at the factory. For example, the scanner-scale may be connected to an auto-locate system, such as a Global Positioning System (GPS) disposed in a PDT connected to the scanner-scale 10, whereby the GPS accesses satellite signals, calculates a location and provides location information to the scanner-scale. Upon knowing its location, the re-calibration system may then extract from a memory (or the store computer or some other source such as via an internet link) the proper scale calibration data for that location. The re-calibration system then may provide adjustment data to the auto-calibration.

Though the present invention has been set forth in the form of its preferred embodiments, it is nevertheless intended that modifications to the disclosed systems and methods may be made without departing from inventive concepts set forth herein.

1. A method of auto-calibrating the scale of a combined data reader-scale system installed at a given location, comprising the steps of
(a) engaging a calibration sequence;
(b) using a built-in accelerometer to obtain gravity calibration data for the given location;
(c) using the gravity calibration data to auto-calibrate the scale for the given location.

2. A method according to claim 1 wherein the step of engaging the calibration sequence comprises scanning a programming label with the data reader to obtain data from the programming label that serves to instruct the system to commence the calibration sequence.

3. A method according to claim 1 wherein the step of engaging the calibration sequence comprises actuating a mechanical switch disposed on a housing of the system.

4. A method according to claim 1 wherein the step of engaging the calibration sequence is engaged upon startup of the system.

5. A method according to claim 1 further comprising obtaining a temperature measurement from a temperature sensor, and adjusting the gravity calibration data to compensate for temperature sensitivity of the accelerometer using the temperature measurement obtained.

6. A method according to claim 5 further comprising storing in a memory calibration data corresponding to a plurality of temperatures.

7. A method according to claim 1 further comprising obtaining a humidity reading from a humidity sensor, calibrating the accelerometer using the temperature reading obtained.

8. A method according to claim 1 wherein the step of engaging the calibration sequence comprises periodically engaging the calibration sequence.

9. A method according to claim 1 wherein the step of using a built-in accelerometer to obtain gravity calibration data for the given location comprises
measuring local acceleration due to gravity to obtain a local acceleration measurement,
calculating the gravity calibration data using the local acceleration measurement.

10. A scanner-scale system with a self-calibrating scale, comprising
an integrated scanner-scale combination including a scale and a data reader;
an internal calibration system contained within the scanner-scale, including (a) an accelerometer operative for obtaining a measurement of acceleration due to gravity corresponding to current location, and (b) a processor operative to use the measurement of acceleration due to gravity from the accelerometer to calibrate the scale.

11. A scanner-scale system according to claim 10 wherein the internal calibration system further comprises a temperature sensor for obtaining a temperature measurement, wherein the processor is operative to compensate for temperature sensitivity of the accelerometer using the temperature measurement when calibrating the scale.

12. A scanner-scale system according to claim 10 wherein the internal calibration system further comprises a humidity sensor for obtaining a humidity measurement, wherein the processor is operative to compensate for humidity sensitivity of the accelerometer using the humidity measurement when calibrating the scale.

13. For a scanner-scale having a communication port, a calibration system for calibrating the scale of the scanner-scale system, the calibration system comprising
a housing;
a connector operative for connecting to the communication port of the scanner-scale;
electronics contained within the housing, including (a) an accelerometer operative for obtaining a measurement of acceleration due to gravity corresponding to current location, and (b) a processor operative to use the measurement of acceleration due to gravity from the accelerometer to calibrate the scale via the communication port.
